(19) United States
(12) Patent Application Publication
(10) Pub. No.: US 2022/0332062 A1
(43) Pub. Date: Oct. 20, 2022

(54) Multi-Layer Pre-Fabricated Covering Device

(71) Applicant: Faserverbund Innovations UG (haftungsbeschränkt), Ibbenburen (DE)

(72) Inventor: Dominik Dierkes, Ibbenbüren (DE)

(21) Appl. No.: 17/723,504

(22) Filed: Apr. 19, 2022

(30) Foreign Application Priority Data
Apr. 19, 2021 (DE) 10 2021 109 829.7

(51) Int. Cl. B29C 70/54; B29C 70/44; B29C 33/00

(52) U.S. Cl. CPC B29C 70/544; B29C 70/443; B29C 33/0038

(57) ABSTRACT

A covering device for a component space in a tool for producing fiber composite components is a multi-layer pre-fabricated material cloth provided with a gas-permeable, matrix material-impermeable membrane. A gas-impermeable, matrix material-impermeable film is provided. Membrane and film are connected at their circumferential rims to delimit an evacuation space with a flow aid and closed by a matrix material-tight connection. Gas having passed from the component space through the membrane into the evacuation space is evacuated through an opening of the film away from the component space. A contact element arranged at a side of the film facing away from the evacuation space surrounds the opening of the film. It is connected matrix material-tightly to the film. The contact element has a contact surface at a side facing away from the film for attaching the covering device to an inner side of a tool wall delimiting the component space.

### BACKGROUND OF THE INVENTION

The present invention relates to a multi-layer covering device for covering a component space in a tool for producing a fiber composite component, with a layer of a gas-permeable but matrix material-impermeable membrane and a gas-impermeable and matrix material-impermeable film that delimit between them an evacuation space for evacuation of a gas which has passed from the component space through the membrane into the evacuation space, and a layer of a flow aid arranged in the evacuation space between the membrane and the film, as well as to a method for sealing a venting opening in a tool for producing a fiber composite component.

From the publication DE 10 2017 130 201 A1 it is known to produce the component space in a tool for producing a fiber composite component with a covering device of the aforementioned kind, wherein the individual layers of the covering device are placed successively onto the open tool.

From the publication US 2020/0238637 it is known to use a multi-part tool whose parts circumferentially delimit a mold cavity. The tool comprises venting openings through which gas present in the mold cavity and in the injected matrix material can be evacuated.

It is a problem to seal the venting openings against the escape of matrix material. It is difficult to align the known multiple layers in the tool such that gas present in the component space can indeed be discharged through the venting opening. The film must be open at a suitable location and sealed in relation to the venting opening. When the sealing action is not perfectly realized, this can lead to the venting opening clogging and the fiber composite component that is produced incompletely in this way is to be discharged as waste. When matrix material flows into the venting opening, the latter is clogged and gas can no longer be evacuated from the mold cavity.

A further problem is to be seen in that the venting opening can evacuate gas from the matrix material only in the mouth region of the venting opening. An evacuation across a larger surface area is not possible with this tool. Even though it is possible to cover the component space in the known manner successively with the multiple layers of the covering device, this type of covering entails however a significant manual labor expenditure and a significant material consumption.

It is the object of the present invention to provide a solution with which the venting openings of multi-part tools for producing a fiber composite component can be sealed in a simple manner against ingress of matrix material. Also, a solution is to be found in this context as to how the vacuum action of the venting opening can be expanded across the surface.

### SUMMARY OF THE INVENTION

The object is solved for a covering device of the aforementioned kind in that the covering device is configured as a multi-layer pre-fabricated material cloth, the evacuation space of the covering device is closed at its circumferential rims by an at least matrix material-tight connection of the membrane to the film, the film has an opening that is designed to enable escape of the gas that has flowed into the evacuation space in a direction that is remote from the component space, a contact elem ent is arranged at the side of the film that is facing away from the evacuation space, which contact element surrounds the opening, is connected at least matrix material-tightly to the film, and comprises a contact surface at its side facing away from the film with which the covering device can be placed on the inner side of a tool wall delimiting the component space.

The object is solved for a method of the aforementioned kind in that, for sealing against ingress of matrix material, a covering device according to the invention is used.

The covering device which is embodied as a pre-fabricated material cloth can be placed as a single piece with the contact element on the inner side of the tool wall in the region of the venting opening. The membrane blocks the evacuation space within the covering device against liquid matrix material that is introduced into the component space. On the side which is positioned opposite the membrane, the film seals the evacuation space in a gas-tight and matrix material-tight manner against the matrix material.

In place of a film, an at least matrix material-tight membrane could be used here also; however, a film is more beneficial in this context without having to accept technical disadvantages. Since the film is contacting with its exterior side the inner side of the tool wall in the normal application situation, no or only little matrix material can be present thereat.

The membrane and the film that are connected at least matrix material-tightly to each other at the rims delimit in this way an evacuation space which is sealed against the matrix material and through which gas can be evacuated from the component space through the membrane. In order to avoid a flat contact of the film on the membrane which causes the evacuation space to collapse so that gas can no longer flow through it anymore, a flow aid is placed into the evacuation space. The flow aid is comprised, for example, of a fibrous material such as a nonwoven or a knit material that can still be flowed through by the gas and that, even under the action of a vacuum applied to the tool, holds the membrane and the film at a spacing from each other.

The covering device comprises an opening in the film through which gas that has been sucked into the evacuation space can flow out of the covering device in direction of the venting opening. By means of the membrane, the covering device thus keeps matrix material away from the venting opening, but gas that has been evacuated from the component space can however flow from the evacuation space through the opening freely into the venting opening so that the gas evacuation from the component space through the covering device functions.

The sealing action of the covering device in relation to the inner side of the tool wall is realized by the contact element that is a component of the covering device. The contact element is placed with its side facing away from the covering device onto the inner side of the tool wall; it is positioned at a location in such a way that gas which has been sucked from the component space into the evacuation space of the covering device can flow out of the opening of the film into the venting opening of the tool. The contact element forms a kind of collar and reinforcement for the film in the region of the opening. The contact element can be shaped such that it is contacting with form fit the wall of the venting opening. It can be held, for example, by holding sockets, clips, and the like in the installed position. However, it is also possible to hold the covering device by means of the contact surface of the contact element by vacuum in the region of the venting opening or to use other fastening auxiliaries, for example, adhesive or the like that imparts an adhesion between the contact surface and the inner side of the tool wall.

Since the contact element is connected at least in a matrix material-tight manner to the film, the matrix material which is present in the component space and/or in the matrix material cannot flow into the venting opening via the transition region between the film and the contact element. When the connection is embodied not only matrix material-tightly but also gas-tightly, gas also cannot flow through the connecting zone. The vacuum acts therefore only on the membrane and gas passes only through the membrane into the evacuation space and into the venting opening. Of course, the connection between the contact surface of the contact element and the inner side of the tool wall can be embodied at least matrix material-tightly.

With the covering device according to the invention, the venting openings of multi-part tools for producing a fiber composite component can be sealed in a simple manner against ingress of matrix material in that the covering device is simply placed from the component space side onto the inlet opening. It is no longer required to place individual layers of a cover in the mouth region of the venting opening into the component space, to fasten them, and to seal them. Since the layers are already connected to each other and sealed to form the finished covering device, only the individual covering device must be attached in the mouth region of the venting opening. Subsequent sealing work is obsolete.

When a covering device is connected to a venting opening, it is possible to evacuate gas from the component space across the entire surface area of the membrane. Since the surface area of the membrane in a preferred embodiment of the covering device is larger than the cross section surface area of the venting opening, the evacuation is carried out across a larger surface area as it would be the case if the gas were evacuated only through the venting opening.

According to an embodiment of the invention, the contact surface is provided with an adhesive layer with which the covering device can be secured on the inner side of the tool wall delimiting the component space. When the contact surface is provided with an adhesive layer, it is sufficient for application and fastening of the covering device at the tool wall that the covering device with the contact surface is pushed against the inner side of the tool wall. The covering device is then fixedly attached in its nominal position without additional work being required for this.

According to an embodiment of the invention, the adhesive layer can be provided with a peel-off film that is not sticky outwardly. The peel-off film protects the adhesive layer against an accidental adhesion to other objects prior to the intended use.

According to an embodiment of the invention, the adhesive layer and the contact surface are embodied for producing an at least matrix material-tight contact at the inner side of a tool wall delimiting the component space. The shape, size, and surface property of the contact surface must be designed such that in the respective application no matrix material can reach via the connecting zone of the contact element the tool wall in the region of the venting opening. The adhesive which is used in the adhesive layer is designed such that it is not dissolved by the matrix material during the flooding and curing phase of the matrix material and holds the covering device operationally safe in the installed position.

According to an embodiment of the invention, the opening is of a round configuration and the contact element surrounds the opening with a contact surface that is also of a round configuration. The round shapes match shapes of the venting openings that are usually also round. Minimal dimensional differences can be compensated by a generous dimensioning of the contact surface of the contact element so that a covering device fits venting openings of various sizes.

According to an embodiment of the invention, the contact surface comprises a width in radial direction away from the center of the opening that corresponds to at least one fourth of the diameter of the opening. The width of the contact surface makes it possible to place the covering device onto venting openings of various sizes. By means of the width of the contact surfaces, it is however also possible to compensate local unevenness and soiling, which may be present in the connecting region and may lead to leaks of the connection, across the larger surrounding contact surface.

According to an embodiment of the invention, the membrane and the film are thermally welded to each other at the circumferential rims. As a connection, the weld connection can be produced inexpensively, quickly, and in a functionally safe manner.

According to an embodiment of the invention, the contact element is produced from a butyl rubber with a contact surface of a closed embodiment. The butyl rubber comprises an elastic behavior, dampens vibration energy and impact energy well, and provides a good resistance against acids and bases. It deforms under the action of pressure and adapts thus optimally to the contours of the surrounding regions of the venting opening. In this way, the contact element can flexibly adapt to the respective shape of the inner side of a tool wall delimiting the component space and can reliably contact it in a seal-tight manner.

According to an embodiment of the invention, the size of the planar surface of the covering device surpasses more than fivefold the cross section surface area of the opening. With such a size ratio, a beneficial relationship is provided between the evacuation action of the covering device and the discharge of the evacuated gas through the venting opening.

Further features of the invention result from the claims, the figure, and the subject matter description. All features and feature combinations mentioned above in the description as well as the features and feature combinations mentioned in the following in the figure description and/or disclosed only in the figure can be used not only in the respectively disclosed combination but also in any other combinations or even individually.

### BRIEF DESCRIPTION OF THE DRAWING

The invention will now be explained in more detail with the aid of a preferred embodiment as well as with reference to the attached drawing.

FIG. 1 shows a cross section of a covering device arranged in a component space of a tool for producing a fiber composite component.

### DESCRIPTION OF PREFERRED EMBODIMENTS

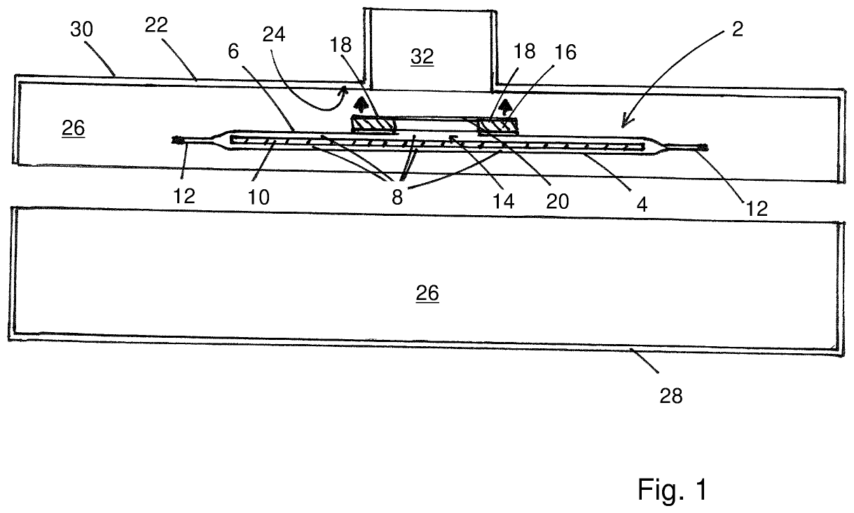

FIG. 1 shows a cross section of a covering device 2 which is arranged in the component space 26 of a tool. The covering device 2 comprises at one side the membrane 4 and at the other side the film 6. The membrane 4 and the film 6 bound the evacuation space 8, provided with a flow aid 10, through which the gas, sucked through the membrane 4 from the component space 26, flows in the direction toward the opening 14. In order to prevent ingress of matrix material into the evacuation space 8, the membrane 4 and the film 6 are connected to each other at least matrix material-tightly in the region of the circumferential rims 12.

At the side of the covering device 2 which is facing away from the component space 26, a contact element 16 is placed onto the exterior side of the film 6 in the region of the opening 14. With the contact surface 18 formed at the contact element 16, the covering device 2 can be attached in the region of the venting opening 32 to the inner side 24 of the tool wall 22. In order to improve adhesion of the covering device 2 at the tool wall 22, at the contact surface 18 an adhesive layer 20 can be arranged by means of which the covering device 2 is glued to the tool wall 22.

In the attached FIG. 1, the covering device 2 is not yet fastened to the tool wall 22. In order to fasten the covering device 2 to the tool wall 22, it must be pushed in the direction of the two arrows via the contact surface 18 onto the tool wall 22. Thereafter, it is at least material-tightly connected to the inner side 24 of the tool wall 22. As can be seen in FIG. 1, the diameter of the opening 14 and of the venting opening 32 do not precisely match. The dimensional differences are however compensated by the width of the contact surface 18 so that a covering device 2 with an opening 14 whose diameter is smaller than the diameter of the venting opening 32 nonetheless can be used for sealing such a venting opening.

In the embodiment illustrated in FIG. 1, the tool is comprised of a first part 28 that bounds the bottom part of the component space 26 and a second part 30 that covers the component space 26 in upward direction. Preferably, the layers of the fibers that reinforce the finished component are placed into the first part 28 prior to the component space 26 being closed and being flooded with matrix material, for example, by means of the vacuum infusion method. When the parts 28, 30 are placed on each other, the component space 26 is closed. After closing of the tool, the component space 26 is evacuated by a vacuum that is applied to the venting opening 32. For reasons of simplification, the vacuum pump with its corresponding hose conduits as well as the tank and the supply line for supplying the matrix material are not illustrated in FIG. 1.

Finally, it should be noted that the size of the covering device 2 illustrated in FIG. 1 as well as of its components in relation to the venting opening 32, the tool as a whole, and the size ratio of the individual components of the covering device 2 relative to each other as well as the shape, arrangement, and dimensions of the individual components may deviate from the illustrated embodiment.

The invention is not limited to the afore described embodiments. A person of skill in the art will have no difficulties to modify the embodiments in a manner that appears suitable to him in order to adapt them to a concrete application situation.

The specification incorporates by reference the entire disclosure of German priority document 10 2021 109 829.7 having a filing date of Apr. 19, 2021.

While specific embodiments of the invention have been shown and described in detail to illustrate the inventive principles, it will be understood that the invention may be embodied otherwise without departing from such principles.

### LIST OF REFERENCE CHARACTERS

2 covering device
4 membrane
6 film
8 evacuation space
10 flow aid
12 circumferential rim
14 opening
16 contact element
18 contact surface
20 adhesive layer
22 tool wall
24 inner side
26 component space
28 first part of tool
30 second part of tool
32 venting opening

What is claimed is:

1. A covering device for covering a component space in a tool for producing a fiber composite component, wherein the covering device is a multi-layer pre-fabricated material cloth comprising:
a membrane that is gas-permeable but matrix material-impermeable and comprises a circumferential rim;
a film that is gas-impermeable and matrix material-impermeable and comprises a circumferential rim, wherein the membrane and the film are connected to each other at the circumferential rims to delimit an evacuation space closed at the circumferential rims by an at least matrix material-tight connection, wherein the evacuation space is configured to evacuate a gas, having passed from the component space of the tool into the evacuation space through the membrane, from the evacuation space in a direction away from the component space of the tool through an opening of the film;
a layer of a flow aid arranged in the evacuation space between the membrane and the film;
a contact element arranged at a side of the film facing away from the evacuation space, wherein the contact element surrounds the opening of the film and is connected at least matrix material-tightly to the film;
wherein the contact element comprises a contact surface at a side of the contact element facing away from the film, wherein the contact surface is configured to attach the covering device to an inner side of a tool wall of the tool delimiting the component space.

2. The covering device according to claim 1, further comprising an adhesive layer disposed on the contact surface and configured to fix the covering device to the inner side of the tool wall delimiting the component space.

3. The covering device according to claim 2, wherein the adhesive layer is provided with a peel-off film that is not sticky outwardly.

4. The covering device according to claim 2, wherein the adhesive layer and the contact surface are embodied to produce an at least matrix material-tight contact on the inner side of the tool wall delimiting the component space.

5. The covering device according to claim 1, wherein the opening of the film is of a round configuration and the contact surface surrounding the opening of the film is of a round configuration.

6. The covering device according to claim 1, wherein the contact surface comprises a width in a radial direction away from a center of the opening of the film and wherein the width corresponds to at least one fourth of a diameter of the opening of the film.

7. The covering device according to claim 1, wherein the membrane and the film are thermally welded to each other at the circumferential rims.

8. The covering device according to claim 1, wherein the contact element is comprised of a butyl rubber with the contact surface having a closed embodiment.

9. The covering device according to claim 1, wherein the covering device has a planar surface of a size surpassing more than fivefold a cross section surface area of the opening of the film.

10. A method for sealing a venting opening in a tool for producing a fiber composite component, comprising:
arranging a covering device according to claim 1 at the venting opening to seal against ingress of matrix material into the venting opening.
